(19) United States
(12) Patent Application Publication
(10) Pub. No.: US 2011/0203037 A1
(43) Pub. Date: Aug. 25, 2011

(54) FIBER, CLOTH, AND UNDERWEAR

(75) Inventors: Koichi Naka, Moriyama-shi (JP); Soichi Sueto, Moriyama-shi (JP); Koji Kuroda, Moriyama-shi (JP)

(73) Assignee: GUNZE LIMITED, Ayabe-shi, Kyoto (JP)

(21) Appl. No.: 13/121,590

(22) PCT Filed: Sep. 18, 2009
(86) PCT No.: PCT/JP2009/066368

§ 371 Date: May 11, 2011

(30) Foreign Application Priority Data
Sep. 30, 2008 (JP) 2008-254662
Nov. 20, 2008 (JP) 2008-296784

(51) Int. Cl. A41B 9/00; D04H 13/00; D03D 15/00; D04B 21/00; C08K 5/524; C08L 53/00

(52) U.S. Cl. 2/400; 442/327; 442/181; 442/304; 524/502; 524/505

(57) ABSTRACT

It is an object of the present invention to provide fibers, a clothing fabric, and underwear which can maintain excellent cool contact feeling, texture, and pleasant feeling and can suppress fiber yellowing and reddening in distribution process or during in use.

The present invention provides fibers containing a thermoplastic elastomer, an acidic compound, and a phosphorus antioxidant, wherein the acidic compound is a styrene-maleic anhydride copolymer or an acid anhydride and the acidic compound is contained in an amount of 0.1 parts by weight or more per 100 parts by weight of the thermoplastic elastomer.

### TECHNICAL FIELD

The present invention relates to fibers, a clothing fabric, and underwear which can maintain excellent cool contact feeling, texture, and pleasant feeling and suppress fiber yellowing and reddening in distribution process or during in use.

### BACKGROUND ART

In recent years, as underwear for summer season, fibers excellent in sensation of coolness and fiber products using the fibers have been investigated.

A function of giving such a sensation of coolness may be, cool contact feeling which causes cool sensation at the time of putting a fiber product on. As fibers excellent in such cool contact feeling, Patent Document 1 and Patent Document 2 disclose fibers containing polyamide elastomers.

However, these fibers have a defect that the fibers cause yellowing and reddening in distribution process or during in use. Concretely, there is a problem that the fibers have a trouble of causing yellowing and reddening due to exhaust gases from engines and turbines of automobiles and the like, or discharge gases of petroleum heating apparatuses such as fan heaters.

A cause of occurrence of such yellowing and reddening is supposed to be relevant to the reaction of nitrogen oxide compounds and water in atmospheric air and amino groups of polymers constituting the fibers. It has been also pointed out that the cause may be relevant to the nitrogen oxide compounds and water and a hindered phenol antioxidant and a hindered amine light stabilizer (HALS) added in the production process of polymers constituting the fibers.

Further, there is another problem that in the case where polyamide elastomer fibers are used for clothing materials such as underwear and sportswear, yellowing occurs significantly when the clothing materials receive ultraviolet rays in a state where alkaline sweat remains in the clothing materials. In such a case, yellowing proceeds further by repeat of wear and laundry.

These problems of yellowing and reddening are particularly serious in the case of underwear and sportswear made of white or light-colored fibers and considerably reduce their commercial values.

To deal with these problems, various methods have been proposed as methods for providing fibers containing polyamide elastomers with resistance against yellowing. Patent Document 3 discloses a method for treating the fibers with an aqueous medium containing an acid anhydride and a surfactant.

However, this method has a problem that the effect of yellowing prevention treatment is lowered by laundering and thus the disadvantage that the yellowing proceeds due to the remaining sweat and ultraviolet rays cannot be suppressed sufficiently.

Patent Document 4 discloses a method of mixing an acidic liquid mixture at the time of fiber spinning.

However, this method has a problem that fiber spinning properties are considerably lowered and deterioration of physical properties by ultraviolet rays are significantly increased; that is, yarn break occurs frequently and yarn physical properties are lowered.

### PRIOR ART DOCUMENTS

### Patent Documents

Patent Document 1: Japanese Kokai Publication 2004-270075 (JP-A 2004-270075)

Patent Document 2: Japanese Kokai Publication 2005-036361 (JP-A 2005-036361)

Patent Document 3: Japanese Patent No. 3757446

Patent Document 4: Japanese Kokai Publication Hei 01-229810 (JP-A Hei01-229810)

### DISCLOSURE OF THE INVENTION

### Problems to be Solved by the Invention

In view of the above state of the art, it is an object of the present invention to provide fibers, a clothing fabric, and underwear which can maintain excellent cool contact feeling, texture, and pleasant feeling and suppress fiber yellowing and reddening in distribution process or during in use.

### Means for Solving the Problems

The present invention provides fibers containing a thermoplastic elastomer, an acidic compound, and a phosphorus antioxidant, wherein the acidic compound is a styrene-maleic anhydride copolymer or an acid anhydride and the acidic compound is contained in amount of 0.1 parts by weight or more per 100 parts by weight of the thermoplastic elastomer.

Hereinafter, the present invention will be described in detail.

The present inventors made earnest investigations and consequently have found that yellowing and reddening of fibers in distribution process or during in use can be suppressed and excellent cool contact feeling, texture and pleasant feeling can be maintained by adding prescribed amounts or more of an acidic compound and a phosphorus antioxidant to fibers containing a thermoplastic elastomer and excellent in cool contact feeling and accordingly, the fibers are preferably usable for clothing materials, particularly for underwear and the like. These findings have low led to completion of the present invention.

The fibers of the present invention contain a thermoplastic elastomer.

The fibers containing a thermoplastic elastomer can cause cool sensation at the time of putting a fiber product directly on the skin and give a sensation of coolness.

The above-mentioned thermoplastic elastomer is preferably a polyamide elastomer.

The polyamide elastomer is not particularly limited, and examples thereof include polyether block amide copolymers, polyether amide copolymers, polyester amide copolymers, and the like. They may be used alone or two or more of them may be used in combination.

Examples of commercialized products of the polyamide elastomer include Pebax (manufactured by Arkema), UBE Nylon (manufactured by Ube Industries, Ltd.), Grilon ELX and Grilamid ELY (both are manufactured by EMS Showa Denko), and Daiamid and Vestamid (both are manufactured by Daicel-Degussa Ltd.).

A polyether block amide copolymer represented by the following formula (1) is particularly preferable among the above-mentioned thermoplastic elastomers since the copolymer provides an extremely excellent antistatic effect, is excellent in the spinnability, and has low specific gravity so that lightweight clothing fabrics and underwear can be produced. Examples of commercialized products of the polyether block amide copolymer include Pebax (manufactured by Arkema).

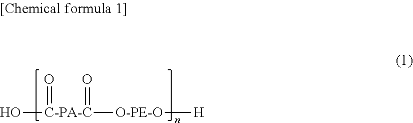

In the formula (1), PA denotes a polyamide and PE denotes a polyether.

The fibers of the present invention contain an acidic compound, which is a styrene-maleic anhydride copolymer or an acid anhydride.

In the present invention, use of such an acidic compound remarkably improves resistance of the fibers against yellowing and reddening.

In the case where a styrene-maleic anhydride copolymer is used as the acidic compound, the effect of preventing yellowing and reddening is easily maintained even if laundering is repeated and the effect of suppressing discoloration is significant even in the environments in which sunlight is received particularly in a state where sweat components remain in the fibers.

The styrene-maleic anhydride copolymer includes a segment derived from styrene and a segment derived from maleic anhydride. In the ratio between the segment derived from styrene and the segment derived from maleic anhydride, the segment derived from maleic anhydride is preferably ⅓ to 1 and more preferably 1 per 1 of the segment derived from styrene.

The weight average molecular weight (Mw) of the styrene-maleic anhydride copolymer is 1000 as a preferable lower limit and 50000 as a preferable upper limit. If it is less than 1000, bleeding out of fiber surfaces may occur and if it exceeds 50000, slub as a defect of threads may tend to be generated in the fibers in some cases.

In the case where the above-mentioned styrene-maleic anhydride copolymer is used as the acidic compound, the content of the styrene-maleic anhydride copolymer in the fibers of the present invention is 0.1 parts by weight as a lower limit and 3.0 parts by weight as a preferable upper limit per 100 parts by weight of the thermoplastic elastomer. If it is less than 0.1 parts by weight, no effect of suppressing yellowing and reddening can be caused and if it exceeds 3.0 parts by weight, the physical properties of the fibers themselves are lowered and yarn break sometimes occurs at the time of fiber spinning and thus the spinnability may be lowered in some cases. The content of the styrene-maleic anhydride copolymer is 0.2 parts by weight as a preferable lower limit and 0.3 parts by weight as a more preferable lower limit and the content of the styrene-maleic anhydride copolymer is 2.0 parts by weight as a preferable upper limit and 1.5 parts by weight as a more preferable upper limit.

Examples of the acid anhydride include phthalic anhydride, maleic anhydride, acetic anhydride, benzoic anhydride, succinic anhydride, nicotinic anhydride, propionic anhydride, n-caproic anhydride, glutaric anhydride, formic anhydride, tetrahydrophthalic anhydride and trifluoroacetic anhydride. Especially, phthalic anhydride is preferable.

In the case where the above-mentioned acid anhydride is used as the acidic compound, the content of the acid anhydride in the fibers of the present invention is 0.1 parts by weight as a lower limit and 2.0 parts by weight as a preferable upper limit per 100 parts by weight of the thermoplastic elastomer. If it is less than 0.1 parts by weight, no effect of suppressing yellowing and reddening can be caused and if it exceeds 2.0 parts by weight, the physical properties of the fibers themselves are lowered and yarn break sometimes occurs at the time of fiber spinning and thus the spinnability may be lowered in some cases. The content of the acid anhydride is 0.15 parts by weight as a preferable lower limit and 0.2 parts by weight as a more preferable lower limit and the content of the acid anhydride is 1.0 part by weight as a more preferable upper limit and 0.6 parts by weight as an even more preferable upper limit.

The fibers of the present invention contain a phosphorus antioxidant. Addition of the above-mentioned phosphorus antioxidant remarkably improves particularly the reddening resistance.

Additionally, in the present invention, the phosphorus antioxidant means an antioxidant containing a phosphorus atom and is preferably an antioxidant having a structure of P(OR)₃. Herein, R is an alkyl group, an alkylene group, an aryl group, an arylene group or the like, and three Rs may be the same or different and arbitrary two Rs may be bonded to each other to form a ring structure.

Examples of the above-mentioned phosphorus antioxidant include tris(nonylphenyl) phosphite (“Nocrac TNP”, manufactured by Ouchi Shinko Chemical Industrial Co., Ltd.), tris(2,4-di-tert-butylphenyl)phosphite (“Irgafos 168”, manufactured by Ciba Inc.),
tris[2-[[2,4,8,10-tetra-tert-butyldibenzo[d,f][1,3,2]dioxaphosphephine-6-yl]oxy]ethyl]amine (“Irgafos 12”, manufactured by Ciba Inc.),
bis[2,4-bis(1,1-dimethylethyl)-6-methylphenyl]ethyl ester phosphite (“Irgafos 38”, manufactured by Ciba Inc.),
bis(2,4-di-tert-butylphenyl)pentaerythritol diphosphite (“Irgafos 126”, manufactured by Ciba Inc.),
tetrakis(2,4-di-tert-butylphenyl)[1,1-biphenyl]-4,4′-diyl bisphosphonite (“Irgafos P-EPQ”, manufactured by Ciba Inc.),
bis(2,6-di-tert-butyl-4-methylphenyl)pentaerythritol diphosphite (“ADK Stab PEP 36”, manufactured by ADEKA Corporation), distearyl pentaerythritol diphosphite (“ADK Stab PEP 8”, manufactured by ADEKA Corporation), and
2,4,8,10-tetra-tert-butyl-6-[3-(3-methyl-4-hydroxy-5-tert-butylphenyl)propoxy]dibenzo[d,f][1,3,2]dioxaphosphepine (“Sumilizer GP”, manufactured by Sumitomo Chemical Co., Ltd.).

The content of the above-mentioned phosphorus antioxidant in the fibers of the present invention is 0.1 parts by weight as a lower limit and 1.5 parts by weight as a preferable upper limit per 100 parts by weight of the thermoplastic elastomer. If it is less than 0.1 parts by weight, no effect of suppressing reddening can be caused and if it exceeds 1.5 parts by weight, bleeding from the fibers tends to occur and powdering may be caused in some cases. It is 0.15 parts by weight as a more preferable lower limit and 1.0 part by weight as a more preferable upper limit; and it is 0.2 parts by weight as an even more preferable lower limit and 0.6 parts by weight as an even more preferable upper limit.

An aspect of the fibers of the present invention is not particularly limited and the fibers may include only the above-mentioned thermoplastic elastomer, acidic compound, and phosphorus antioxidant; however, in general, the fibers using the above-mentioned thermoplastic elastomer sometimes give sticky feeling and fiber spinning is difficult in some cases. In such a case, other resins may be used in combination.

The fibers of the present invention may contain additives such as an inorganic filler, a flame-retardant, an ultraviolet absorbent, an antistatic agent, a light stabilizer, an inorganic substance and a higher fatty acid salt, within an extent that the effects of the present invention are not hindered.

In the case where the fibers of the present invention contain other resins other than the thermoplastic elastomer, the fibers may be fibers obtained by fiber spinning of a mixture of these resins or conjugated fibers.

The other resins are not particularly limited and examples thereof include polyamide resins such as nylon 6, nylon 66, nylon 11 and nylon 12; polyester resins such as PET, PBT and PTT; rayon and acrylic polymers. Especially, polyamide resins are preferable. These resins may be used alone or two or more of them may be used in combination.

In the case where the other resins are used, for preventing discoloration in composite interface or contact interface, it is preferable to add the above-mentioned acidic compound and phosphorus antioxidant to the other resins at the ratios same as those of the acidic compound and phosphorus antioxidant to the thermoplastic elastomer.

The above-mentioned conjugated fibers are not particularly limited and examples thereof include core-sheath type conjugated fibers, side-by-side type conjugated fibers, radiation type conjugated fibers and hollow circular conjugated fibers.

In the case where the fibers of the present invention are the above-mentioned core-sheath type conjugated fibers, the thermoplastic elastomer may be used for the core and the other resins may be used for the sheath part, or the other resins may be used for the core part and the above-mentioned thermoplastic elastomer may be used for the sheath part.

The shapes of the above-mentioned core-sheath type conjugated fibers are not particularly limited and may be truly circular or elliptical as a cross sectional shape when the fibers are cut perpendicularly to the longitudinal direction of the fibers. Further, the fibers may be concentric core-sheath type conjugated fibers in which the core part and the sheath part are formed concentrically or eccentric core-sheath type conjugated fibers in which the core part and the sheath part are formed eccentrically. Furthermore, the fibers may be partially opened core-sheath type conjugated fibers in which the sheath part is partially opened. In addition, the fibers may have a structure in which a plurality of core parts exist in the case where the fibers are cut perpendicularly to the longitudinal direction of the fibers.

The fibers of the present invention are preferable to have a qₘₐₓ value of 0.2 J/sec/cm² or higher.

The qₘₐₓ value is defined as a peak value of the heat flow quantity of stored heat transferring to a sample at a lower temperature in the case a prescribed heat is stored in a heat plate with a specified surface area and a specified weight and immediately after the heat plate is brought into contact with the sample surface. The qₘₐₓ value is supposed to simulate the body temperature transferred to the sample when the sample is put on and thus it is supposed that as the qₘₐₓ value is higher, the body temperature transferred is larger at the time of putting the sample on, and cool contact feeling is more significant. If the qₘₐₓ value is less than 0.2 J/sec/cm², most of examinees do not feel cool contact feeling in a sensory test. It is more preferably 0.21 J/sec/cm² or higher and even more preferably 0.22 J/sec/cm² or higher.

The fibers of the present invention are preferable to have a heat conductivity of 1×10^{-3o} C/W·m² or higher. The heat conductivity is supposed to be one of important parameters corresponding to cool contact feeling. If the heat conductivity is less than 1×10^{-3o} C/W·m², most of examinees may sometimes not feel cool contact feeling in a sensory test.

Additionally, the heat conductivity can be calculated according to the following formula (2) by layering a heat plate on a sample put on a sample stand, and measuring the heat loss rate after stabilizing the temperature of the heat plate at a prescribed temperature.

Heat conductivity (W/cm/° C.)=W·D/A/ΔT (2)

W: heat flow rate (J/sec)

D: Thickness of sample (cm)

A: Heat plate area (cm²)

ΔT: Temperature difference between sample stand and heat plate (° C.)

A method for producing the fibers of the present invention is not particularly limited and conventionally known methods such as a method of melt spinning of pellets containing the above-mentioned thermoplastic elastomer, the acidic compound, and the phosphorus antioxidant may be employed.

Further, in the case of obtaining conjugated fibers using other resins as described above, a method for obtaining conjugated fibers by loading a composite spinning apparatus with pellets containing the thermoplastic elastomer, the acidic compound, and the phosphorus antioxidant and pellets containing the other resins and carrying out melt spinning, or the like is employed.

The fibers of the present invention can give actual cool contact feeling satisfactorily in a sensory level. Use of the fibers of the present invention makes most of persons feel cool sensation at the time of putting a fiber product on and gives a sensation of coolness. Further, the fibers can maintain white color and light color for a long duration, and thus the fibers are also preferably usable for underwear.

A clothing fabric produced from the fibers of the present invention is also included in the present invention.

In this description, the clothing fabric includes a knitted material, a woven fabric, a nonwoven fabric and the like.

The clothing fabric of the present invention may be a fabric produced only from the fibers of the present invention; however the fabric may be produced by weaving the fibers with other fibers for improving the requirement for underwear such as pleasant feeling within an extent that an object of the present invention is not hindered. The other fibers are not particularly limited, and examples thereof include polyamide resins such as nylon 6 and nylon 12; polyesters, cotton, rayon, and the like.

Underwear produced by using the fibers of the present invention or the clothing fabric of the present invention is also included in the present invention.

### Effects of the Invention

The present invention can provide fibers, a clothing fabric, and underwear which can maintain excellent cool contact feeling, texture, and pleasant feeling and suppress fiber yellowing and reddening in distribution process or during in use.

### MODE FOR CARRYING OUT THE INVENTION

Hereinafter, the present invention will be described in detail with reference to examples; however, it is not intended that the present invention be limited to these examples.

### EXAMPLE 1

After 60 parts by weight of a polyether block amide copolymer (“Pebax MV1041SA01”, manufactured by Arkema) and 40 parts by weight of a polyether block amide copolymer (“Pebax 6333SA01”, manufactured by Arkema), a thermoplastic polyamide elastomer, 1 part by weight of a styrene-maleic anhydride copolymer (“SMA 1000”, manufactured by Sartomer Japan Inc.), 0.6 parts by weight of a phosphorus antioxidant (“ADK Stab PEP 36”, manufactured by ADEKA Corporation), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### EXAMPLE 2

After 60 parts by weight of a polyether block amide copolymer (“Pebax MV1041SA01”, manufactured by Arkema) and 40 parts by weight of a polyether block amide copolymer (“Pebax 6333SA01”, manufactured by Arkema), a thermoplastic polyamide elastomer, 1.5 parts by weight of a styrene-maleic anhydride copolymer (“SMA 1000”, manufactured by Sartomer Japan Inc.), 1 part by weight of a phosphorus antioxidant (“ADK Stab PEP 36”, manufactured by ADEKA Corporation), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### EXAMPLE 3

After 60 parts by weight of a polyether block amide copolymer (“Pebax MV1041SA01”, manufactured by Arkema) and 40 parts by weight of a polyether block amide copolymer (“Pebax 6333SA01”, manufactured by Arkema), a thermoplastic polyamide elastomer, 2 parts by weight of a styrene-maleic anhydride copolymer (“SMA 1000”, manufactured by Sartomer Japan Inc.), 0.15 parts by weight of a phosphorus antioxidant (“Irgafos 126”, manufactured by Ciba Inc.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### EXAMPLE 4

After 60 parts by weight of a polyether block amide copolymer (“Pebax MV1041SA01”, manufactured by Arkema) and 40 parts by weight of a polyether block amide copolymer (“Pebax 6333SA01”, manufactured by Arkema), a thermoplastic polyamide elastomer, 0.3 parts by weight of a styrene-maleic anhydride copolymer (“SMA 1000”, manufactured by Sartomer Japan Inc.), 0.2 parts by weight of a phosphorus antioxidant (“Sumilizer GP”, manufactured by Sumitomo Chemical Co., Ltd.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### EXAMPLE 5

After 60 parts by weight of a polyether block amide copolymer (“Pebax MV1041SA01”, manufactured by Arkema) and 40 parts by weight of a polyether block amide copolymer (“Pebax 6333SA01”, manufactured by Arkema), a thermoplastic polyamide elastomer, 0.2 parts by weight of a styrene-maleic anhydride copolymer (“SMA 1000”, manufactured by Sartomer Japan Inc.), 0.5 parts by weight of a phosphorus antioxidant (“Sumilizer GP”, manufactured by Sumitomo Chemical Co., Ltd.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### EXAMPLE 6

After 100 parts by weight of a polyether block amide copolymer (“Pebax MV1041SA01”, manufactured by Arkema), a thermoplastic polyamide elastomer, 0.3 parts by weight of phthalic anhydride, 0.6 parts by weight of a phosphorus antioxidant (“Sumilizer GP”, manufactured by Sumitomo Chemical Co., Ltd.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### EXAMPLE 7

After 100 parts by weight of a polyether block amide copolymer (“Pebax MV1041SA01”, manufactured by Arkema), a thermoplastic polyamide elastomer, 0.6 parts by weight of phthalic anhydride, 0.2 parts by weight of a phosphorus antioxidant (“Sumilizer GP”, manufactured by Sumitomo Chemical Co., Ltd.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### EXAMPLE 8

After 100 parts by weight of a polyether block amide copolymer (“Pebax MV1041SA01”, manufactured by Arkema), a thermoplastic polyamide elastomer, 1 part by weight of phthalic anhydride, 0.15 parts by weight of a phosphorus antioxidant (“Irgafos 126”, manufactured by Ciba Inc.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### EXAMPLE 9

After 100 parts by weight of a polyether block amide copolymer (“Pebax MV1041SA01”, manufactured by Arkema), a thermoplastic polyamide elastomer, 0.2 parts by weight of phthalic anhydride, 0.5 parts by weight of a phosphorus antioxidant (“ADK Stab PEP 36”, manufactured by ADEKA Corporation), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### EXAMPLE 10

After 100 parts by weight of a polyether block amide copolymer (“Pebax MV1041SA01”, manufactured by Arkema), a thermoplastic polyamide elastomer, 0.1 parts by weight of phthalic anhydride, 1 part by weight of a phosphorus antioxidant (“ADK Stab PEP 36”, manufactured by ADEKA Corporation), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### EXAMPLE 11

After 100 parts by weight of a polyether block amide copolymer (“Pebax MV1074SA01”, manufactured by Arkema), a thermoplastic polyamide elastomer as a resin for a sheath part, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A for a sheath part were produced by using a pelletizer.

After 100 parts by weight of nylon 6 (“UBE Nylon 1011FB”, manufactured by Ube Industries, Ltd.), a polyamide resin as a resin for a core part, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B for a core part were produced by using a pelletizer.

Next, the obtained resin pellets A for a sheath part and resin pellets B for a core part were respectively heated and melted by a uniaxial extruder and subjected to conjugated spinning to form a circular cross section for the core part and an approximately C-shaped cross section for the sheath part, and thus obtaining partially opened eccentric core-sheath type conjugated fibers with a fineness of 120 dtex (composed of 36 filaments). The obtained conjugated fibers had a diameter per one filament of about 20 μm and the occupation ratio of the core part to the cross section area of the fiber was 80%.

The obtained conjugated fibers were woven to produce a circular rib-knitted fabric.

### EXAMPLE 12

After 100 parts by weight of a polyether block amide copolymer (“Pebax MV1074SA01”, manufactured by Arkema), a thermoplastic polyamide elastomer as a resin for a core part, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A for a core part were produced by using a pelletizer.

After 100 parts by weight of nylon 6 (“UBE Nylon 1011FB”, manufactured by Ube Industries, Ltd.), a polyamide resin as a resin for a sheath part, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B for a sheath part were produced by using a pelletizer.

Next, the obtained resin pellets A for a core part and resin pellets B for a sheath part were respectively heated and melted by a uniaxial extruder and subjected to conjugated spinning to form a circular cross section for the core part and an approximately C-shaped cross section for the sheath part, and thus obtaining partially opened eccentric core-sheath type conjugated fibers with a fineness of 120 dtex (composed of 36 filaments). The obtained conjugated fibers had a diameter per one filament of about 20 μm and the occupation ratio of the core part to the cross section area of the fiber was 80%.

The obtained conjugated fibers were woven to produce a circular rib-knitted fabric.

### EXAMPLE 13

After 100 parts by weight of a polyether block amide copolymer (“Pebax MV1074SA01”, manufactured by Arkema), a thermoplastic polyamide elastomer, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A were produced by using a pelletizer.

After 100 parts by weight of nylon 11 (“Rilsan BESN TL”, manufactured by Arkema), a polyamide resin, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B were produced by using a pelletizer.

Next, the obtained resin pellets A and resin pellets B were respectively heated and melted by a uniaxial extruder and subjected to conjugated spinning to respectively form a semi-circular cross section, and thus obtaining side-by-side type conjugated fibers with a fineness of 120 dtex (composed of 36 filaments). The obtained conjugated fibers had a diameter per one filament of about 20 μm and the occupation ratio of the core part to the cross section area of the fiber was 50%.

The obtained conjugated fibers were woven to produce a circular rib-knitted fabric.

### EXAMPLE 14

After 100 parts by weight of a polyether block amide copolymer (“Pebax MV1074SA01”, manufactured by Arkema), a thermoplastic polyamide elastomer, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A were produced by using a pelletizer.

After 100 parts by weight of nylon 12 (“UBESTA 3014B”, manufactured by Ube Industries, Ltd.), a polyamide resin, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B were produced by using a pelletizer.

Next, the obtained resin pellets A and resin pellets B were respectively heated and melted by a uniaxial extruder and subjected to conjugated spinning to respectively form a semi-circular cross section, and thus obtaining side-by-side type conjugated fibers with a fineness of 120 dtex (composed of 36 filaments). The obtained conjugated fibers had a diameter per one filament of about 20 μm and the occupation ratio of the core part to the cross section area of the fiber was 50%.

The obtained conjugated fibers were woven to produce a circular rib-knitted fabric.

### EXAMPLE 15

After 100 parts by weight of a polyether block amide copolymer (“Pebax MV1074SA01”, manufactured by Arkema), a thermoplastic polyamide elastomer as a resin for a sheath part, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A for a sheath part were produced by using a pelletizer.

After 100 parts by weight of a thermoplastic polyester elastomer (“Pelprene P-1503”, manufactured by Toyobo Co., Ltd.) as a resin for a core part, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B for a core part were produced by using a pelletizer.

Next, the obtained resin pellets A for a sheath part and resin pellets B for a core part were respectively heated and melted by a uniaxial extruder and subjected to conjugated spinning to form a circular cross section for the core part and a ring-shaped cross section for the sheath part, and thus obtaining concentric core-sheath type conjugated fibers with a fineness of 120 dtex (composed of 36 filaments). The obtained conjugated fibers had a diameter per one filament of about 20 μm and the occupation ratio of the core part to the cross section area of the fiber was 70%.

The obtained conjugated fibers were woven to produce a circular rib-knitted fabric.

### EXAMPLE 16

After 100 parts by weight of a polyether block amide copolymer (“Pebax MV1074SA01”, manufactured by Arkema), a thermoplastic polyamide elastomer as a resin for a core part, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A for a core part were produced by using a pelletizer.

After 100 parts by weight of a thermoplastic polyester elastomer (“Pelprene P-150B”, manufactured by Toyobo Co., Ltd.) as a resin for a sheath part, 1 part by weight of a styrene-maleic anhydride copolymer (“SMA1000”, manufactured by Sartomer Japan Inc.), 0.3 parts by weight of a phosphorus antioxidant (“Sumilizer GP”, manufactured by Sumitomo Chemical Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B for a sheath part were produced by using a pelletizer.

Next, the obtained resin pellets A for a core part and resin pellets B for a sheath part were respectively heated and melted by a uniaxial extruder and subjected to conjugated spinning to form a circular cross section for the core part and a ring-shaped cross section for the sheath part, and thus obtaining concentric core-sheath type conjugated fibers with a fineness of 120 dtex (composed of 36 filaments). The obtained conjugated fibers had a diameter per one filament of about 20 μm and the occupation ratio of the core part to the cross section area of the fiber was 70%.

The obtained conjugated fibers were woven to produce a circular rib-knitted fabric.

### COMPARATIVE EXAMPLE 1

After 60 parts by weight of a polyether block amide copolymer (“Pebax MV1041SA01”, manufactured by Arkema) and 40 parts by weight of a polyether block amide copolymer (“Pebax 63335A01”, manufactured by Arkema), a thermoplastic polyamide elastomer, 0 .6 parts by weight of a phosphorus antioxidant (“ADK Stab PEP 36”, manufactured by ADEKA Corporation), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### COMPARATIVE EXAMPLE 2

After 60 parts by weight of a polyether block amide copolymer (“Pebax MV1041SA01”, manufactured by Arkema) and 40 parts by weight of a polyether block amide copolymer (“Pebax 6333SA01”, manufactured by Arkema), a thermoplastic polyamide elastomer, 1 part by weight of a phosphorus antioxidant (“ADK Stab PEP 36”, manufactured by ADEKA Corporation), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### COMPARATIVE EXAMPLE 3

After 60 parts by weight of a polyether block amide copolymer (“Pebax MV1041SA01”, manufactured by Arkema) and 40 parts by weight of a polyether block amide copolymer (“Pebax 6333SA01”, manufactured by Arkema), a thermoplastic polyamide elastomer, 0.05 parts by weight of a styrene-maleic anhydride copolymer (“SMA 1000”, manufactured by Sartomer Japan Inc.), 0.15 parts by weight of a phosphorus antioxidant (“Irgafos 126”, manufactured by Ciba Inc.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### COMPARATIVE EXAMPLE 4

After 60 parts by weight of a polyether block amide copolymer (“Pebax MV1041SA01”, manufactured by Arkema) and 40 parts by weight of a polyether block amide copolymer (“Pebax 6333SA01”, manufactured by Arkema), a thermoplastic polyamide elastomer, 0.3 parts by weight of a styrene-maleic anhydride copolymer (“SMA 1000”, manufactured by Sartomer Japan Inc.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### COMPARATIVE EXAMPLE 5

After 60 parts by weight of a polyether block amide copolymer (“Pebax MV1041SA01”, manufactured by Arkema) and 40 parts by weight of a polyether block amide copolymer (“Pebax 6333SA01”, manufactured by Arkema), a thermoplastic polyamide elastomer, 0.2 parts by weight of a styrene-maleic anhydride copolymer (“SMA 1000”, manufactured by Sartomer Japan Inc.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 p.m and a fineness of 120 dtex (composed of 36 filaments) was obtained by yarn-making according to a melt spinning method. The obtained raw yarn was woven to produce a circular rib-knitted fabric.

### COMPARATIVE EXAMPLE 6

After 100 parts by weight of a polyether block amide copolymer (“Pebax MV1041SA01”, manufactured by Arkema), a thermoplastic polyamide elastomer, 0.6 parts by weight of a phosphorus antioxidant (“Sumilizer GP”, manufactured by Sumitomo Chemical Co., Ltd.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### COMPARATIVE EXAMPLE 7

After 100 parts by weight of a polyether block amide copolymer (“Pebax MV1041SA01”, manufactured by Arkema), a thermoplastic polyamide elastomer, 0.2 parts by weight of a phosphorus antioxidant (“Sumilizer GP”, manufactured by Sumitomo Chemical Co., Ltd.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### COMPARATIVE EXAMPLE 8

After 100 parts by weight of a polyether block amide copolymer (“Pebax MV1041SA01”, manufactured by Arkema), a thermoplastic polyamide elastomer, 0.05 parts by weight of phthalic anhydride, 0.15 parts by weight of a phosphorus antioxidant (“Irgafos 126”, manufactured by Ciba Inc.), 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### COMPARATIVE EXAMPLE 9

After 100 parts by weight of a polyether block amide copolymer (“Pebax MV1041SA01”, manufactured by Arkema), a thermoplastic polyamide elastomer, 0.2 parts by weight of phthalic anhydride, 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### COMPARATIVE EXAMPLE 10

After 100 parts by weight of a polyether block amide copolymer (“Pebax MV1041SA01”, manufactured by Arkema), a thermoplastic polyamide elastomer, 0.1 parts by weight of phthalic anhydride, 5 parts by weight of titanium oxide (“D-918”, manufactured by Sakai Chemical Industry Co., Ltd.), 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets were produced by using a pelletizer. Next, the obtained resin pellets were used and a raw yarn with a diameter per one filament of about 20 μm and a fineness of 120 dtex (composed of 36 filaments) was obtained by yarn-making according to a melt spinning method. The obtained raw yarn was woven to produce a circular rib-knitted fabric.

### COMPARATIVE EXAMPLE 11

After 100 parts by weight of a polyether block amide copolymer (“Pebax MV1074SA01”, manufactured by Arkema), a thermoplastic polyamide elastomer as a resin for a sheath part, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A for a sheath part were produced by using a pelletizer.

After 100 parts by weight of nylon 6 (“UBE Nylon 1011FB”, manufactured by Ube Industries, Ltd.), a polyamide resin as a resin for a core part, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B for a core part were produced by using a pelletizer.

Next, the obtained resin pellets A for a sheath part and resin pellets B for a core part were respectively heated and melted by a uniaxial extruder and subjected to conjugated spinning to form a circular cross section for the core part and an approximately C-shaped cross section for the sheath part, and thus obtaining partially opened eccentric core-sheath type conjugated fibers with a fineness of 120 dtex (composed of 36 filaments). The obtained conjugated fibers had a diameter per one filament of about 20 μm and the occupation ratio of the core part to the cross section area of the fiber was 80%.

The obtained conjugated fibers were woven to produce a circular rib-knitted fabric.

### COMPARATIVE EXAMPLE 12

After 100 parts by weight of a polyether block amide copolymer (“Pebax MV1074SA01”, manufactured by Arkema), a thermoplastic polyamide elastomer as a resin for a core part, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A for a core part were produced by using a pelletizer.

After 100 parts by weight of nylon 6 (“UBE Nylon 1011FB”, manufactured by Ube Industries, Ltd.), a polyamide resin as a resin for a sheath part, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B for a sheath part were produced by using a pelletizer.

Next, the obtained resin pellets A for a core part and resin pellets B for a sheath part were respectively heated and melted by a uniaxial extruder and subjected to conjugated spinning to form a circular cross section for the core part and an approximately C-shaped cross section for the sheath part, and thus obtaining partially opened eccentric core-sheath type conjugated fibers with a fineness of 120 dtex (composed of 36 filaments). The obtained conjugated fibers had a diameter per one filament of about 20 μm and the occupation ratio of the core part to the cross section area of the fiber was 80%.

The obtained conjugated fibers were woven to produce a circular rib-knitted fabric.

### COMPARATIVE EXAMPLE 13

After 100 parts by weight of a polyether block amide copolymer (“Pebax MV1074SA01”, manufactured by Arkema), a thermoplastic polyamide elastomer, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A were produced by using a pelletizer.

After 100 parts by weight of nylon 11 (“Rilsan BESN TL”, manufactured by Arkema), a polyamide resin, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B were produced by using a pelletizer.

Next, the obtained resin pellets A and resin pellets B were respectively heated and melted by a uniaxial extruder and subjected to conjugated spinning to respectively form a semi-circular cross section, and thus obtaining side-by-side type conjugated fibers with a fineness of 120 dtex (composed of 36 filaments). The obtained conjugated fibers had a diameter per one filament of about 20 μm and the occupation ratio of the core part to the cross section area of the fiber was 50%.

The obtained conjugated fibers were woven to produce a circular rib-knitted fabric.

### COMPARATIVE EXAMPLE 14

After 100 parts by weight of a polyether block amide copolymer (“Pebax MV1074SA01”, manufactured by Arkema), a thermoplastic polyamide elastomer, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A were produced by using a pelletizer.

After 100 parts by weight of nylon 12 (“UBESTA 3014B”, manufactured by Ube Industries, Ltd.), a polyamide resin, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B were produced by using a pelletizer.

Next, the obtained resin pellets A and resin pellets B were respectively heated and melted by a uniaxial extruder and subjected to conjugated spinning to respectively form a semi-circular cross section, and thus obtaining side-by-side type conjugated fibers with a fineness of 120 dtex (composed of 36 filaments). The obtained conjugated fibers had a diameter per one filament of about 20 μm and the occupation ratio of the core part to the cross section area of the fiber was 50%. The obtained conjugated fibers were woven to produce a circular rib-knitted fabric.

### COMPARATIVE EXAMPLE 15

After 100 parts by weight of a polyether block amide copolymer (“Pebax MV1074SA01”, manufactured by Arkema), a thermoplastic polyamide elastomer as a resin for a sheath part, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A for a sheath part were produced by using a pelletizer.

After 100 parts by weight of a thermoplastic polyester elastomer (“Pelprene P-150B”, manufactured by Toyobo Co., Ltd.) as a resin for a core part, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B for a core part were produced by using a pelletizer.

Next, the obtained resin pellets A for a sheath part and resin pellets B for a core part were respectively heated and melted by a uniaxial extruder and subjected to conjugated spinning to form a circular cross section for the core part and a ring-shaped cross section for the sheath part, and thus obtaining concentric core-sheath type conjugated fibers with a fineness of 120 dtex (composed of 36 filaments). The obtained conjugated fibers had a diameter per one filament of about 20 μm and the occupation ratio of the core part to the cross section area of the fiber was 70%.

The obtained conjugated fibers were woven to produce a circular rib-knitted fabric.

### COMPARATIVE EXAMPLE 16

After 100 parts by weight of a polyether block amide copolymer (“Pebax MV1074SA01”, manufactured by Arkema), a thermoplastic polyamide elastomer as a resin for a core part, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets A for a core part were produced by using a pelletizer.

After 100 parts by weight of a thermoplastic polyester elastomer (“Pelprene P-150B”, manufactured by Toyobo Co., Ltd.) as a resin for a sheath part, 0.3 parts by weight of an ultraviolet absorbent (“Tinuvin 234”, manufactured by Ciba Inc.), and 0.3 parts by weight of a light stabilizer (“Tinuvin 144”, manufactured by Ciba Inc.) were added, the mixture was melted and mixed and resin pellets B for a sheath part were produced by using a pelletizer.

Next, the obtained resin pellets A for a core part and resin pellets B for a sheath part were respectively heated and melted by a uniaxial extruder and subjected to conjugated spinning to form a circular cross section for the core part and a ring-shaped cross section for the sheath part, and thus obtaining concentric core-sheath type conjugated fibers with a fineness of 120 dtex (composed of 36 filaments). The obtained conjugated fibers had a diameter per one filament of about 20 μm and the occupation ratio of the core part to the cross section area of the fiber was 70%.

The obtained conjugated fibers were woven to produce a circular rib-knitted fabric.

### (Evaluation)

The thermoplastic elastomers used in examples and comparative examples and the obtained fabrics were evaluated according to the following methods. The results are shown in Tables 1 to 4.

### (1) Courtaulds Yellowing Test

Each clothing fabric sample of 3 cm x 10 cm in size was produced and the sample was sandwiched with testing paper containing 0.01% dibutylnitrophenol and further pinched with glass plates. Next, the sample was sealed with a film containing no dibutylhydroxytoluene (BHT) and stored at 50±3° C. for 16 hours while being pressed with a weight so as not to form a gap between the clothing fabric sample and the testing paper. Thereafter, the sample was cooled to room temperature and the film and glass plates were removed and immediately after that, the degree of yellowing of the clothing fabric was measured by a gray scale (JIS L 0805). The evaluation was five-scale evaluation from 1 to 5 grades graded by every 0.5 grade and in the case of gaining 4 or higher grade, the sample was determined to be good.

### (2) NOx Yellowing Test

In accordance with JIS L 0855 “Intensive test” of “Method for testing color fastness to nitrogen oxide”, the degree of yellowing was measured by using a measurement device (Macbeth WHITE-EYE3000) and evaluated in accordance with the variation (ΔD* value) of the b* value before and after the test in CIELAB color system. It means that yellowing was more significant as the Δb* value was higher.

Δb* value=(b* value after test)−(b* value before test)

### (3) Fan Heater Reddening Test

Each clothing fabric sample of 5 cm×10 cm in size was produced and thereafter, the sample was set at a distance of 90 cm from the blowing port of a pump-spray type kerosene fan heater (KD-25CTD, manufactured by Mitsubishi Electric Corporation) and after the fan heater was operated for 24 hours in total, the degree of reddening of each clothing fabric sample was investigated. This evaluation was carried out in consideration of the discoloration issue in the case where NOx, SOx, and highly humid environments affected simultaneously. The degree of reddening was measured by using a measurement device (Macbeth WHITE-EYE3000) and evaluated in accordance with the variation (Δa* value) of the a* value before and after the test in CIELAB color system. It means that reddening was more significant as the Δa* value was higher.

Δa* value=(a* value after test)−(a* value before test)

### (4) Sweat and Light-Fastness Test

In accordance with a method defined in JIS L 0888 “B test” of “Method for testing color fastness to light and sweat”, the measurement was carried out using an alkaline artificial sweat solution and an ultraviolet carbon arc lamp type light-fastness tester.

(5) Measurement of qₘₐₓ Value

Each clothing fabric was put on a sample stand set at a temperature of 20.5° C. and a heat storage plate warmed at 32.5° C. was put on the clothing fabric at a contact pressure of 0.098 N/cm² and immediately after that, the peak value of the stored heat quantity transferred to a sample in a low temperature side was measured. A thermo-lab II type equipment for precise and quick measurement of heat physical property (manufactured by Kato Tech Co., Ltd.) was employed for the measurement.

TABLE 1

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 |
| Composition | Thermoplastic | Pebax | 60 | 60 | 60 | 60 | 60 | 100 | 100 | 100 | 100 | 100 |
| (parts by | elastomer | MV1041SA01 | | | | | | | | | | |
| weight) | | Pebax | 40 | 40 | 40 | 40 | 40 | 0 | 0 | 0 | 0 | 0 |
| | | 6333SA01 | | | | | | | | | | |
| | Acidic | Styrene-maleic | 1 | 1.5 | 2 | 0.3 | 0.2 | 0 | 0 | 0 | 0 | 0 |
| | compound | anhydride copolymer | | | | | | | | | | |
| | | Phthalic anhydride | 0 | 0 | 0 | 0 | 0 | 0.3 | 0.6 | 1 | 0.2 | 0.1 |
| | Phosphorus | ADK Stab PEP 36 | 0.6 | 1 | 0 | 0 | 0 | 0 | 0 | 0 | 0.5 | 1 |
| | antioxidant | irgafos126 | 0 | 0 | 0.15 | 0 | 0 | 0 | 0 | 0.15 | 0 | 0 |
| | | Sumilizer-GP | 0 | 0 | 0 | 0.2 | 0.5 | 0.6 | 0.2 | 0 | 0 | 0 |
| | Other | Titanium oxide | 5 | 5 | 5 | 5 | 5 | 5 | 5 | 5 | 5 | 5 |
| | additives | (D-918) | | | | | | | | | | |
| | | Ultraviolet absorbent | 0.3 | 0.3 | 0.3 | 0.3 | 0.3 | 0.3 | 0.3 | 0.3 | 0.3 | 0.3 |
| | | (Tinuvin 234) | | | | | | | | | | |
| | | Light stabilizer | 0.3 | 0.3 | 0.3 | 0.3 | 0.3 | 0.3 | 0.3 | 0.3 | 0.3 | 0.3 |
| | | (Tinuvin 144) | | | | | | | | | | |

| | | | | | | | | | | | |
|---|---|---|---|---|---|---|---|---|---|---|---|
| Evaluation | Courtaulds yellowing | 5 Grade | 5 Grade | 5 Grade | 5 Grade | 5 Grade | 4 Grade | 4 Grade | 4 Grade | 4 Grade | 4 Grade |
| | test | | | | | | | | | | |
| | NOₓ yellowing test | 0.2 | 0.2 | 0.2 | 0.4 | 0.8 | 1.8 | 1.5 | 1.5 | 2.0 | 2.0 |
| | Δb* value | | | | | | | | | | |
| | Fan heater reddening | 0.9 | 0.6 | 1.8 | 1.8 | 0.5 | 0.5 | 2.0 | 2.0 | 0.7 | 0.6 |
| | test Δa* value | | | | | | | | | | |
| | Sweat and light- | 5 Grade | 5 Grade | 5 Grade | 5 Grade | 5 Grade | 4 Grade | 4 Grade | 4 Grade | 4 Grade | 4 Grade |
| | fastness test | | | | | | | | | | |
| | qₘₐₓ value | 0.23 | 0.23 | 0.23 | 0.23 | 0.23 | 0.24 | 0.24 | 0.24 | 0.24 | 0.24 |

TABLE 2

| | | | | Example 11 | Example 12 | Example 13 |
|---|---|---|---|---|---|---|
| Conjugated type | | | | Partially opened | Partially opened | Side-by-side |
| | | | | eccentric core- | eccentric core- | |
| | | | | sheath | sheath | |
| Resin pellet A | Composition | Thermoplastic | Pebax | 100 | 100 | 100 |
| | (parts by weight) | elastomer | MV1074SA01 | | | |
| | | Acidic compound | Styrene-maleic | 1 | 1 | 1 |
| | | | anhydride copolymer | | | |
| | | Phosphorus antioxidant | Sumilizer-GP | 0.3 | 0.3 | 0.3 |
| | | Other additives | Ultraviolet absorbent | 0.3 | 0.3 | 0.3 |
| | | | (Tinuvin 234) | | | |
| | | | Light stabilizer | 0.3 | 0.3 | 0.3 |
| | | | (Tinuvin 144) | | | |
| | Cross-sectional shape | | | Approximately | Circular | Semi-circular |
| | | | | C-shaped (sheath) | shape (core) | |
| | Occupation ratio to cross section area of fiber(%) | | | 20 | 80 | 50 |
| Resin pellet B | Composition | Other resins | UBE Nylon 1011FB | 100 | 100 | — |
| | (parts by weight) | | Rilsan BESN TL | — | — | 100 |
| | | | UBESTA 3014B | — | — | — |
| | | | Pelprene P-150B | — | — | — |
| | | Acidic compound | Styrene-maleic | 1 | 1 | 1 |
| | | | anhydride copolymer | | | |
| | | Phosphorus antioxidant | Sumilizer-GP | 0.3 | 0.3 | 0.3 |
| | | Other additives | Ultraviolet absorbent | 0.3 | 0.3 | 0.3 |
| | | | (Tinuvin 234) | | | |
| | | | Light stabilizer | 0.3 | 0.3 | 0.3 |
| | | | (Tinuvin 144) | | | |

| | | | |
|---|---|---|---|
| Cross-sectional shape | Circular | Approximately | Semi-circular |
| | shape (core) | C-shaped (sheath) | |
| Occupation ratio to cross section area of fiber(%) | 80 | 20 | 50 |

| Evaluation | Courtaulds yellowing test | 5 Grade | 5 Grade | 5 Grade |
|---|---|---|---|---|
| | NOₓ yellowing test | 0.5 | 0.5 | 0.4 |
| | Δb* value | | | |
| | Fan heater reddening test | 0.5 | 1.2 | 0.7 |
| | Δa* value | | | |
| | Sweat and light-fastness test | 5 Grade | 5 Grade | 5 Grade |
| | qₘₐₓ value | 0.20 | 0.25 | 0.21 |

| | | | | Example 14 | Example 15 | Example 16 |
|---|---|---|---|---|---|---|
| Conjugated type | | | | Side-by-side | Concentric | Concentric |
| | | | | | core-sheath | core-sheath |
| Resin pellet A | Composition | Thermoplastic | Pebax | 100 | 100 | 100 |
| | (parts by weight) | elastomer | MV1074SA01 | | | |
| | | Acidic compound | Styrene-maleic | 1 | 1 | 1 |
| | | | anhydride copolymer | | | |
| | | Phosphorus antioxidant | Sumilizer-GP | 0.3 | 0.3 | 0.3 |
| | | Other additives | Ultraviolet absorbent | 0.3 | 0.3 | 0.3 |
| | | | (Tinuvin 234) | | | |
| | | | Light stabilizer | 0.3 | 0.3 | 0.3 |
| | | | (Tinuvin 144) | | | |
| | Cross-sectional shape | | | Semi-circular | Ring-shaped | Circular |
| | | | | | (sheath) | shape (core) |
| | Occupation ratio to cross section area of fiber(%) | | | 50 | 30 | 70 |
| Resin pellet B | Composition | Other resins | UBE Nylon 1011FB | — | — | — |
| | (parts by weight) | | Rilsan BESN TL | — | — | — |
| | | | UBESTA 3014B | 100 | — | — |
| | | | Pelprene P-150B | — | 100 | 100 |
| | | Acidic compound | Styrene-maleic | 1 | 1 | 1 |
| | | | anhydride copolymer | | | |
| | | Phosphorus antioxidant | Sumilizer-GP | 0.3 | 0.3 | 0.3 |
| | | Other additives | Ultraviolet absorbent | 0.3 | 0.3 | 0.3 |
| | | | (Tinuvin 234) | | | |
| | | | Light stabilizer | 0.3 | 0.3 | 0.3 |
| | | | (Tinuvin 144) | | | |

| | | | |
|---|---|---|---|
| Cross-sectional shape | Semi-circular | Circular | Ring-shaped |
| | | shape (core) | (sheath) |
| Occupation ratio to cross section area of fiber(%) | 50 | 70 | 30 |

| Evaluation | Courtaulds yellowing test | 5 Grade | 5 Grade | 5 Grade |
|---|---|---|---|---|
| | NOₓ yellowing test | 0.4 | 0.2 | 0.2 |
| | Δb* value | | | |
| | Fan heater reddening test | 0.8 | 0.6 | 0.9 |
| | Δa* value | | | |
| | Sweat and light-fastness test | 5 Grada | 5 Grade | 5 Grade |
| | qₘₐₓ value | 0.21 | 0.23 | 0.24 |

TABLE 3

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Composition | Thermoplastic | Pebax | 60 | 60 | 60 | 60 | 60 | 100 |
| (parts by weight) | elastomer | MV1041SA01 | | | | | | |
| | | Pebax | 40 | 40 | 40 | 40 | 40 | 0 |
| | | 6333SA01 | | | | | | |
| | Acidic | Styrene-maleic | 0 | 0 | 0.05 | 0.3 | 0.2 | 0 |
| | compound | anhydride copolymer | | | | | | |
| | | Phthalic anhydride | 0 | 0 | 0 | 0 | 0 | 0 |
| | Phosphorus | ADK Stab PEP 36 | 0.6 | 1 | 0 | 0 | 0 | 0 |
| | antioxidant | irgafos126 | 0 | 0 | 0.15 | 0 | 0 | 0 |
| | | Sumilizer-GP | 0 | 0 | 0 | 0 | 0 | 0.6 |
| | Other | Titanium oxide | 5 | 5 | 5 | 5 | 5 | 5 |
| | additives | (D-918) | | | | | | |
| | | Ultraviolet absorbent | 0.3 | 0.3 | 0.3 | 0.3 | 0.3 | 0.3 |
| | | (Tinuvin 234) | | | | | | |
| | | Light stabilizer | 0.3 | 0.3 | 0.3 | 0.3 | 0.3 | 0.3 |
| | | (Tinuvin 144) | | | | | | |

| Evaluation | Courtaulds yellowing test | 2 Grade | 3 Grade | 1 Grade | 3 Grade | 2 Grade | 3 Grade |
|---|---|---|---|---|---|---|---|
| | NOₓ yellowing test | 4.9 | 3.2 | 5.9 | 3.5 | 4.4 | 3.8 |
| | Δb* value | | | | | | |
| | Fan heater reddening test | 1.8 | 1.3 | 2.2 | 6.6 | 7.9 | 1.5 |
| | Δa* value | | | | | | |
| | Sweat and light-fastness | 3 Grade | 3 Grade | 3 Grade | 3 Grade | 3 Grade | 3 Grade |
| | test | | | | | | |
| | qₘₐₓ value | 0.23 | 0.23 | 0.23 | 0.23 | 0.23 | 0.24 |

| | | | Comparative | Comparative | Comparative | Comparative |
|---|---|---|---|---|---|---|
| | | | Example 7 | Example 8 | Example 9 | Example 10 |
| Composition | Thermoplastic | Pebax | 100 | 100 | 100 | 100 |
| (parts by weight) | elastomer | MV1041SA01 | | | | |
| | | Pebax | 0 | 0 | 0 | 0 |
| | | 6333SA01 | | | | |
| | Acidic | Styrene-maleic | 0 | 0 | 0 | 0 |
| | compound | anhydride copolymer | | | | |
| | | Phthalic anhydride | 0 | 0.05 | 0.2 | 0.1 |
| | Phosphorus | ADK Stab PEP 36 | 0 | 0 | 0 | 0 |
| | antioxidant | irgafos126 | 0 | 0.15 | 0 | 0 |
| | | Sumilizer-GP | 0.2 | 0 | 0 | 0 |
| | Other | Titanium oxide | 5 | 5 | 5 | 5 |
| | additives | (D-918) | | | | |
| | | Ultraviolet absorbent | 0.3 | 0.3 | 0.3 | 0.3 |
| | | (Tinuvin 234) | | | | |
| | | Light stabilizer | 0.3 | 0.3 | 0.3 | 0.3 |
| | | (Tinuvin 144) | | | | |

| Evaluation | Courtaulds yellowing test | 1 Grade | 1 Grade | 2 Grade | 1 Grade |
|---|---|---|---|---|---|
| | NOₓ yellowing test | 6.3 | 6.6 | 5.0 | 7.7 |
| | Δb* value | | | | |
| | Fan heater reddening test | 3.3 | 3.8 | 6.3 | 7.8 |
| | Δa* value | | | | |
| | Sweat and light-fastness | 3 Grade | 3 Grade | 3 Grade | 3 Grade |
| | test | | | | |
| | qₘₐₓ value | 0.24 | 0.24 | 0.24 | 0.24 |

TABLE 4

| | | | | Comparative | Comparative | Comparative |
|---|---|---|---|---|---|---|
| | | | | Example 11 | Example 12 | Example 13 |
| Conjugated type | | | | Partially opened | Partially opened | Side-by-side |
| | | | | eccentric core- | eccentric core- | |
| | | | | sheath | sheath | |
| Resin pellet A | Composition | Thermoplastic elastomer | Pebax | 100 | 100 | 100 |
| | (parts by weight) | | MV1074SA01 | | | |
| | | Acidic compound | Styrene-maleic | — | — | — |
| | | | anhydride copolymer | | | |
| | | Phosphorus antioxidant | Sumilizer-GP | — | — | — |
| | | Other additives | Ultraviolet absorbent | 0.3 | 0.3 | 0.3 |
| | | | (Tinuvin 234) | | | |
| | | | Light stabilizer | 0.3 | 0.3 | 0.3 |
| | | | (Tinuvin 144) | | | |
| | Cross-sectional shape | | | Approximately | Circular | Semi-circular |
| | | | | C-shaped (sheath) | shape (core) | |
| | Occupation ratio to cross section area of fiber(%) | | | 20 | 80 | 50 |
| Resin pellet B | Composition | Other resins | UBE Nylon 1011FB | 100 | 100 | — |
| | (parts by weight) | | Rilsan BESN TL | — | — | 100 |
| | | | UBESTA 3014B | — | — | — |
| | | | Pelprene P-150B | — | — | — |
| | | Acidic compound | Styrene-maleic | — | — | — |
| | | | anhydride copolymer | | | |
| | | Phosphorus antioxidant | Sumilizer-GP | — | — | — |
| | | Other additives | Ultraviolet absorbent | 0.3 | 0.3 | 0.3 |
| | | | (Tinuvin 234) | | | |
| | | | Light stabilizer | 0.3 | 0.3 | 0.3 |
| | | | (Tinuvin 144) | | | |

| | | | |
|---|---|---|---|
| Cross-sectional shaps | Circular | Approximately | Semi-circular |
| | shape (core) | C-shaped (sheath) | |
| Occupation ratio to cross section area of fiber(%) | 80 | 20 | 50 |

| Evaluation | Courtaulds yellowing test | 1 Grade | 1 Grade | 1 Grade |
|---|---|---|---|---|
| | NOₓ yellowing test | 7.1 | 6.1 | 6.9 |
| | Δb* value | | | |
| | Fan heater reddening test | 3.8 | 7.1 | 3.5 |
| | Δa* value | | | |
| | Sweat and light-fastness test | 3 Grade | 3 Grade | 3 Grade |
| | qₘₐₓ value | 0.20 | 0.25 | 0.21 |

| | | | | Comparative | Comparative | Comparative |
|---|---|---|---|---|---|---|
| | | | | Example 14 | Example 15 | Example 16 |
| Conjugated type | | | | Side-by-side | Concentric | Concentric |
| | | | | | core-sheath | core-sheath |
| Resin pellet A | Composition | Thermoplastic elastomer | Pebax | 100 | 100 | 100 |
| | (parts by weight) | | MV1074SA01 | | | |
| | | Acidic compound | Styrene-maleic | — | — | — |
| | | | anhydride copolymer | | | |
| | | Phosphorus antioxidant | Sumilizer-GP | — | — | — |
| | | Other additives | Ultraviolet absorbent | 0.3 | 0.3 | 0.3 |
| | | | (Tinuvin 234) | | | |
| | | | Light stabilizer | 0.3 | 0.3 | 0.3 |
| | | | (Tinuvin 144) | | | |
| | Cross-sectional shape | | | Semi-circular | Ring-shaped | Circular |
| | | | | | (sheath) | shape (core) |
| | Occupation ratio to cross section area of fiber(%) | | | 50 | 30 | 70 |
| Resin pellet B | Composition | Other resins | UBE Nylon 1011FB | — | — | — |
| | (parts by weight) | | Rilsan BESN TL | — | — | — |
| | | | UBESTA 3014B | 100 | — | — |
| | | | Pelprene P-150B | — | 100 | 100 |
| | | Acidic compound | Styrene-maleic | — | — | — |
| | | | anhydride copolymer | | | |
| | | Phosphorus antioxidant | Sumilizer-GP | — | — | — |
| | | Other additives | Ultraviolet absorbent | 0.3 | 0.3 | 0.3 |
| | | | (Tinuvin 234) | | | |
| | | | Light stabilizer | 0.3 | 0.3 | 0.3 |
| | | | (Tinuvin 144) | | | |

| | | | |
|---|---|---|---|
| Cross-sectional snaps | Semi-circular | Circular | Ring-shaped |
| | | shape (core) | (sheath) |
| Occupation ratio to cross section area of fiber(%) | 50 | 70 | 30 |

| Evaluation | Courtaulds yellowing test | 1 Grade | 2 Grade | 2 Grade |
|---|---|---|---|---|
| | NOₓ yellowing test | 7.3 | 4.3 | 5.0 |
| | Δb* value | | | |
| | Fan heater reddening test | 3.3 | 3.9 | 7.0 |
| | Δa* value | | | |
| | Sweat and light-fastness test | 3 Grade | 3 Grade | 3 Grade |
| | qₘₐₓ value | 0.21 | 0.23 | 0.24 |

### INDUSTRIAL APPLICABILITY

The present invention can provide fibers, a clothing fabric, and underwear which can maintain excellent cool contact feeling, texture, and pleasant feeling and can suppress fiber yellowing and reddening in distribution process or during in use.

1. A fiber which comprises a thermoplastic elastomer, an acidic compound, and a phosphorus antioxidant,
wherein the acidic compound is a styrene-maleic anhydride copolymer or an acid anhydride, and
the acidic compound is contained in an amount of 0.1 parts by weight or more per 100 parts by weight of the thermoplastic elastomer.

2. The fiber according to claim 1,
wherein the thermoplastic elastomer is a polyamide elastomer.

3. The fiber according to claim 1,
wherein the thermoplastic elastomer is a polyether block amide copolymer.

4. A clothing fabric produced using the fiber according to claim 1.

5. Underwear produced using the fiber according to claim 1.

6. Underwear produced using the clothing fabric according to claim 4.
